(19) United States
(12) Patent Application Publication
(10) Pub. No.: US 2008/0161466 A1
(43) Pub. Date: Jul. 3, 2008

(54) Composition For Production Flame Retardant Insulating Material of Halogen Free Type Using Nano-Technology

(76) Inventors: Oh-Young Kim, Seoul (KR); Jin-Ho Nam, Seoul (KR); Hwa-Joon Lim, Seoul (KR)

Correspondence Address: JONES DAY, 222 EAST 41ST ST, NEW YORK, NY, 10017, US

(21) Appl. No.: 11/814,888

(22) PCT Filed: May 27, 2005
(86) PCT No.: PCT/KR2005/001570

§ 371 Date: Jul. 26, 2007

(30) Foreign Application Priority Data
Jan. 28, 2005 (KR) 10-2005-0008252

(51) Int. Cl. C08K 3/38; C08K 3/22

(52) U.S. Cl. 524/405

(57) ABSTRACT

Disclosed is a composition for producing a halogen-free flame-retardant insulating material using nano-technology. The present invention provides a composition for producing a halogen-free flame-retardant insulating material using nano-technology, including metal hydroxide treated with nanoboric acid; nano clay which is a compatibility enhancer of a base resin; a metal compound which is a flame-retardant formulation; and an antioxidant, based on the total weight of the polyolefin resin. The composition of the present invention has advantages that, if it is used for the flame-retardant insulating material, especially the insulating coating layer for wire, it maintains the equivalent physical properties such as the tensile strength or the elongation against the mechanical strength in comparison to the conventional products, and also is more environment-friendly than the conventional halogen-containing products, and also ensures the flame retardancy suitable for the standard of the grade VW-I of High Flame Retardance.

### TECHNICAL FIELD

The present invention relates to a composition for producing a halogen-free flame-retardant insulating material using nano-technology, and more particularly to a composition for producing a halogen-free flame-retardant insulating material using nano-technology so as to manufacture an insulating material which does not contain halogen elements, but has an improved flame retardancy by adding nano-size material to a polyolefin-based base resin.

### BACKGROUND ART

Thermoplastic resin such as polyethylene, etc., which has been commonly used as a flame-retardant insulating material, is an organic material composed of flammable materials such as hydrogen and carbon in the chemical structure, and therefore has a high smoke density when a fire breaks out. In addition, the thermoplastic resin has a disadvantage of generating a large amount of smoke containing toxic gases on the fire to cause secondary losses of human lives. Meanwhile, halogen-based flame-retardant insulating materials containing halogens such as bromine (Br), chlorine (Cl), etc. has been used, but the halogen-based insulating materials have a safety problem upon their manufacture and use and generate toxic gases such as dioxine upon combustion. Therefore, there have been attempts to obtain a flame-retardant insulating material that does not contains halogen elements in an environment-friendly aspect.

There have been studies on flame retardancy of various environment-friendly components in the field of the environment-friendly flame retardants in recent years. In particular, it has been revealed that if metal hydroxide-based inorganic flame retardants are used, they satisfy the UL 94 VO requirements but do not satisfy the grade VW-1 of High Flame Retardance. In case inorganic clay is used, then it satisfies UL 94 VO requirements but does not satisfy the grade VW-1 of High Flame Retardance, like the above.

The present invention is designed under the technical background in the related fields to solve the conventional problems.

### DISCLOSURE OF INVENTION

### Technical Problem

Accordingly, the present invention is designed to solve the problems of the prior art, and therefore it is an object of the present invention to provide a composition for producing a halogen-free flame-retardant insulating material using nano-technology, not containing halogen element, which may have flame retardancy that satisfies the grade VW-1.

### Technical Solution

In order to accomplish the above object, the present invention provides a composition for producing a halogen-free flame-retardant insulating material using nano-technology, including 100 to 250 parts by weight of metal hydroxide treated with nanoboric acid which is an inorganic flame retardant; 1 to 50 parts by weight of nano clay which is a compatibility enhancer of a base resin; 1 to 50 parts by weight of pre-determined metal compound which is a flame-retardant formulation; and 0.5 to 5 parts by weight of an antioxidant, based on 100 parts by weight of polyolefin resin which is the base resin.

The polyolefin resin constituting the base resin is preferably an olefin polymer or an ethylene-based copolymer, and the ethylene-based copolymer is more preferably ethylene vinyl acetate (EVA) in which vinyl acetate (VA) has a content of 10 to 40%.

At this time, if the content of vinyl acetate (VA) included in the ethylene-based copolymer is less than the numerical limit, it is difficult to fill retardants, causing a problem in ensuring its predetermined flame retardancy. On the while, if the content of vinyl acetate (VA) exceeds the numerical limit, mechanical strength such as tensile strength or abrasion resistance is deteriorated, which makes it difficult to ensure physical properties of the products.

The nanoboric acid, used for surface-treating metal hydroxide which is an inorganic flame retardant, is selected from the group consisting of orthoboric acid, metaboric acid and tetraboric acid, either alone or in mixture thereof, and it preferably has a size of 1.0 [symbol] or less and a surface area of 1 to 10 [symbol] /g. At this time, the metal hydroxide treated with the nanoboric acid functions to form a solid layer upon combustion, thereby facilitating easy formation of char that improves the flame retardancy. If the content of the inorganic flame retardant is less than the numerical limit, a surface-treating effect of boric acid is not ensured. On the while, if the content of the inorganic flame retardant exceeds the numerical limit, processability and mechanical physical properties of the composition are deteriorated in the extrusion process using the composition. Meanwhile, if the size of the nanoboric acid exceeds the numerical limit, dispersability of the composition is weakened, and therefore the reproducibility of physical properties of the resultant product is deteriorated. And, if the surface area of the nanoboric acid is less than the numerical limit, the reproducibility of physical properties is deteriorated, while, if the surface area of the nanoboric acid exceeds the numerical limit, it is not easy to obtain appropriate materials due to technical difficulties, and therefore the cost is increased in an economic aspect.

The nano clay is selected from the group consisting of montmorillonite, hectorite, vermiculite and saponite, either alone or in mixture thereof, and it preferably has a size of 1.0 [symbol] or less. At this time, the nano clay functions to improve compatibility with the base resin since it has a structure having polar groups. If the content of the nano clay is less than the numerical limit, a level of the formed char is reduced, and therefore its flame retardancy is deteriorated, while if the content of the nano clay exceeds the numerical limit, the product manufactured using the composition has the deteriorated elongation.

The flame-retardant formulation is preferably, but not limited to, molybdenum-based compounds or silica-based compounds. The flame-retardant formulation functions to reinforce the flame retardancy due to solidification of the char and reduce an amount of smoke emitted upon combustion. For example, the flame-retardant formulation preferably includes one or more metal compounds selected from the group consisting of one molybdenum-based compound selected from the group consisting of inorganic additives in which molybdenum complexes are added to phosphated zinc oxide, ammonium octamolybdenum, zinc base, and magnesium oxide and silica are added to molybdenum of zinc base; and one silica-based compound selected from the group consisting of hydrotalcite and ground silica, precipitated silica and foamed silica.

Meanwhile, if the content of the flame-retardant formulation is less than the numerical limit, it is difficult to satisfy the sufficient flame retardancy, while if the content of the flame-retardant formulation exceeds the numerical limit, the product manufactured using the composition may have the deteriorated mechanical strengths such as elongation or tensile strength.

The antioxidant functions to prevent products, manufactured using the composition, from being aged by capturing radicals generated in the products to suppress generation of new radicals. If the content of the antioxidant is less than the numerical limit, it is difficult to expect the effect caused by addition of the antioxidant for the purpose of the aforementioned function, while if the content of the antioxidant exceeds the numerical limit, the composition is not preferred due to occurrence of a blooming or bleed out effect.

Meanwhile, the aforementioned composition for producing a halogen-free flame-retardant insulating material using nano-technology is more preferably used for manufacturing an insulating coating layer for a halogen-free flame-retardant wire.

### BEST MODE FOR CARRYING OUT THE INVENTION

Hereinafter, preferred embodiments of the present invention will be described in detail. However, the description proposed herein is just a preferable example for the purpose of illustrations only, not intended to limit the scope of the invention, so it should be understood that other equivalents and modifications could be made thereto without departing from the spirit and scope of the invention. Preferred embodiments of the present invention will be provided to those skilled in the art for the purpose of more full description of the present invention.

### Embodiments 1 to 4 and Comparative Examples 1 to 4

Embodiments according to the present invention are classified into Embodiments 1 to 4, and into Comparative examples 1 to 4 as control groups, and then their components and contents of the compositions are prepared, respectively, as listed in the following Table 1.

TABLE 1

| | Embodiments | | | | Comparative examples | | | |
|---|---|---|---|---|---|---|---|---|
| | 1 | 2 | 3 | 4 | 1 | 2 | 3 | 4 |
| EVA | 100 | 100 | 100 | 80 | 100 | 100 | 100 | 80 |
| EEA | — | — | — | 20 | — | — | — | 20 |
| Boric acid-treated metal | 180 | 180 | 180 | 180 | 400 | 180 | 100 | 50 |
| hydroxide | | | | | | | | |
| Nano clay | 20 | 20 | 15 | 15 | 20 | 15 | 80 | 15 |
| Molybdenum compound | 15 | — | 5 | 5 | — | — | 80 | 15 |
| Silica compound | — | 15 | 5 | 5 | — | — | — | — |
| Phenol-based antioxidant | 2.0 | 2.0 | 2.0 | 2.0 | 2.0 | 2.0 | 2.0 | 2.0 |
| Processing aid | 2.0 | 2.0 | 2.0 | 2.0 | 2.0 | 2.0 | 2.0 | 2.0 |
| Cross-linking accelerator | 3.0 | 3.0 | 3.0 | 3.0 | 3.0 | 3.0 | 3.0 | 3.0 |
| Total Content | 322.0 | 322.0 | 312.0 | 312.0 | 527.0 | 302.0 | 367.0 | 187.0 |

In the Table 1, EVA represents ethylene vinyl acetate (wherein vinyl acetate has a content of 33%), EEA represents ethylene ethyl acrylate (wherein ethyl acrylate has a content of 24%), metal hydroxide surface-treated with orthoboric acid was used as boric acid-treated metal hydroxide, montmorillonite was used as the nano clay, calcium carbonate treated with ammonium molybdenum was used as the molybdenum compound, ground silica was used as the silica compound, and TMPTMA (Trimethylolpropanetrimethacrlate) was used as the cross-linking accelerator.

Meanwhile, an aliphatic processing aid generally used in the art was used as the processing aid.

Preparation of Insulating Coating Layer for Wire

Sequentially described is a method for manufacturing an insulating material for coating layer of the wire using the composition according to Embodiments 1 to 4 and Comparative examples 1 to 4 listed in the Table 1, as follows.

The compositions according to the Embodiments 1 to 4, and the composition according to the Comparative examples 1 to 4 were prepared, respectively (step S1). The prepared compositions were put into a 120 L kneader, and kneaded for 15 minutes (preferably, 15 to 20 minutes) (step S2). The kneaded compositions were extruded into insulating materials under the extrusion temperature of 150° C. (preferably, 130 to 180° C.) using a 750 single screw extruder (step S3). The extruded flame retardants were cross linked by irradiating electronic beams of 8 Mrad (preferably, 5 to 10 Mrad thereto) (step S4).

Test and Evaluation

Test samples of the insulating materials, prepared along the steps S1 to S4 using the compositions according to Embodiments 1 to 4 and Comparative examples 1 to 4 as described above, were taken, respectively, to be used as the coating layer for wire. And then, the evaluation items of the physical property at break such as tensile strength and elongation were measured according to the UL 1581. The evaluation items of the flame retardancy such as Limited Oxygen Index (LOI) and High Flame Retardance (VW-1) were adopted as the standard for their evaluations. At this time, LOI was measured according to the ASTM D 2863, and VW-1 was evaluated using an apparatus for a Vertical Burning test of the UL standard. The results of the tests and evaluations on the evaluation items of the physical property at break and the flame retardancy were listed in the following Table 2.

TABLE 2

| | | Embodiments | | | | Comparative examples | | | |
|---|---|---|---|---|---|---|---|---|---|
| | | 1 | 2 | 3 | 4 | 1 | 2 | 3 | 4 |
| Physical | Tensile | 1.760 | 1.740 | 1.820 | 1.690 | 1.320 | 1.900 | 1.280 | 2.240 |
| property at | strength | | | | | | | | |
| break | Elongation | 180 | 175 | 190 | 190 | 40 | 210 | 140 | 235 |
| Flame | LOI | 48 | 50 | 47 | 47 | 68 | 44 | 48 | 34 |
| retardancy | VW-1 | Passed | Passed | Passed | Passed | Not | Not | Not | Not |
| | | | | | | passed | passed | passed | passed |

As seen from the Table 2, it was revealed that the tensile strength and the elongation showed relatively uniform values in all Embodiments 1 to 4, and the desired physical properties were satisfied in all products, while the tensile strength and the elongation were evaluated relatively low, and therefore it would be found that problems on the properties of the product appeared in Comparative examples 1 and 3.

Meanwhile, the evaluation items of the flame retardancy were measured using the apparatus for the Vertical Burning test. As a result, it was revealed that defects in the products appeared in all Comparative examples 1 to 4, while there was found no defect in the products from all Embodiments 1 to 4. Therefore, it was confirmed that the inventive effect according to the present invention was sufficiently satisfied in the Embodiments 1 to 4.

As described above, the best embodiments of the present invention has been described in detail. It should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation.

### INDUSTRIAL APPLICABILITY

The composition for producing a halogen-free flame-retardant insulating material using nano-technology according to the present invention has advantages that, if the composition of the present invention is used for a flame-retardant insulating material, especially for an insulating coating layer for wire, it maintains the equivalent physical properties such as the tensile strength or the elongation against the mechanical strength in comparison to the conventional products, and also the composition is more environment-friendly than the conventional halogen-containing products since it does not contain halogen elements, and also ensures the flame retardancy suitable for the standard of the grade VW-1 of High Flame Retardance.

1. A composition for producing a halogen-free flame-retardant insulating material using nano-technology, comprising, based on 100 parts by weight of polyolefin resin which is a base resin:
100 to 250 parts by weight of metal hydroxide treated with nanoboric acid which is an inorganic flame retardant;
1 to 50 parts by weight of nano clay which is a compatibility enhancer of the base resin;
1 to 50 parts by weight of predetermined metal compound which is a flame-retardant formulation; and
0.5 to 5 parts by weight of an antioxidant.

2. The composition for producing a halogen-free flame-retardant insulating material using nano-technology according to the claim 1,
wherein the polyolefin resin constituting the base resin is an olefin polymer or an ethylene-based copolymer.

3. The composition for producing a halogen-free flame-retardant insulating material using nano-technology according to the claim 2,
wherein the ethylene-based copolymer is ethylene vinyl acetate (EVA) in which vinyl acetate (VA) has a content of 10 to 40%.

4. The composition for producing a halogen-free flame-retardant insulating material using nano-technology according to the claim 1,
wherein the nanoboric acid, used for surface-treating metal hydroxide which is the inorganic flame retardant, is selected from the group consisting of orthoboric acid, metaboric acid and tetraboric acid, either alone or in mixture thereof, and has a size of 1.0 [symbol] or less and a surface area of 1 to 10 [symbol] /g.

5. The composition for producing a halogen-free flame-retardant insulating material using nano-technology according to the claim 1,
wherein the nano clay is selected from the group consisting of montmorillonite, hectorite, vermiculite and saponite, either alone or in mixture thereof, and has a size of 1.0 [symbol] or less.

6. The composition for producing a halogen-free flame-retardant insulating material using nano-technology according to the claim 1,
wherein the flame-retardant formulation is one or more metal compounds selected from the group consisting of one molybdenum-based compound selected from the group consisting of inorganic additives in which molybdenum compounds are added to phosphated zinc oxide, ammonium octamolybdenum, zinc base, and magnesium oxide and silica are added to molybdenum of zinc base; and one silica-based compound selected from the group consisting of hydrotalcite and ground silica, precipitated silica and foamed silica.

7. The composition for producing a halogen-free flame-retardant insulating material using nano-technology according to any of the claims 1 to 6, wherein the composition is used for manufacturing a coating layer for a halogen-free flame-retardant wire.
